(19) United States
(12) Patent Application Publication
(10) Pub. No.: US 2004/0215482 A1
(43) Pub. Date: Oct. 28, 2004

(54) Personal competition logbook system

(76) Inventor: Jill M. Davila, Phoenix, AZ (US)

Correspondence Address: STONEMAN LAW OFFICES, LTD, 3113 NORTH 3RD STREET, PHOENIX, AZ, 85012, US

(21) Appl. No.: 10/820,094

(22) Filed: Apr. 6, 2004

Related U.S. Application Data
(60) Provisional application No. 60/465,832, filed on Apr. 25, 2003.

(51) Int. Cl. G06F 17/60

(52) U.S. Cl. 705/1

(57) ABSTRACT

A personal competition logbook system with information, fields and formatting which remind and prompt a user to record the relevant and appropriate data and allows a user to conveniently track and archive results from judged competitions, such as Taekwondo, throughout a competitive season.

### CROSS-REFERENCE TO RELATED APPLICATION

The present application is related to and claims priority from prior provisional application Ser. No. 60/465,832, filed Apr. 25, 2003, entitled “Personal Competition Logbook System”, the contents of which are incorporated herein by this reference and are not admitted to be prior art with respect to the present invention by the mention in this cross-reference section.

### BACKGROUND

This invention relates to providing a personal competition logbook system. Previously, there has not been a convenient way for competitors (or their friends and/or relatives) to conveniently track and archive results from judged competitions throughout a competitive season. Likewise, there has not been a convenient way for competitors to verify the accuracy of results that may be tracked by competition organizers and governing sport authorities. In the past, for example, a parent wishing to track their child's performance in a Taekwondo tournament has had to take notes on blank pieces of paper and may fail to write down information that he/she later wished they had included. People trying to record such tournament performances for personal use may not be familiar with the rules and factors involved in judging and scoring and may forget to include some important information. Also, there has not been a convenient way to organize and archive personal records of competition results and scores so that a competitor can review past performance at a future date.

### OBJECTS OF THE INVENTION

A primary object and feature of the present invention is to provide a personal competition logbook system to allow a user to conveniently track and archive results from judged competitions throughout an individual-sport competitive season of tournaments.

Another object and feature of the present invention is to provide a personal competition logbook system with fields and formatting that remind and prompt a user to record the relevant and appropriate data. Another object and feature of the present invention is to provide a personal competition logbook system that assists a user in organizing an individual competitor's scores, opponents, results and other relevant information and statistics. Another object and feature of the present invention is to provide a personal competition logbook system that allows a user to conveniently compile and archive a chronological collection of an individual's tournament performances over an entire season.

A further primary object and feature of the invention is to provide such a system, which is efficient, inexpensive, and handy for users. Other objects and features of this invention will become apparent with reference to the following descriptions.

### SUMMARY OF THE INVENTION

In accordance with a preferred embodiment hereof, this invention provides a page-based personal logbook system comprising, in combination: at least one plurality of pre-assigned fields adapted to assist entering of individual single-sport competition data relating to at least one plurality of individual-sports tournaments relating to at least one sport; and at least one page organizer system adapted to assist page-organizing of such at least one plurality of pre-assigned fields relating to at least one such individual-sports tournament. Moreover, it provides such a page-based personal logbook system wherein such individual single-sport competition data comprises at least one score based on input from at least one judge. Additionally, it provides such a page-based personal logbook system wherein such at least one page organizer system comprises bound paper pages comprising such at least one plurality of pre-assigned fields. Also, it provides such a page-based personal logbook system wherein such bound paper pages comprise single views related to each of such plurality of individual-sports tournaments. In addition, it provides such a page-based personal logbook system wherein such at least one pre-assigned field comprises tournament identification information relating to each such individual-sports tournament. And, it provides such a page-based personal logbook system wherein such at least one pre-assigned field comprises competitors-identification information relating to each such individual-sports tournament. Further, it provides such a page-based personal logbook system wherein such at least one pre-assigned field comprises judges-identification information relating to each such individual-sports tournament. Even further, it provides such a page-based personal logbook system wherein such at least one pre-assigned field comprises scoring data from each judge relating to each competitor relating to each such individual-sports tournament. Moreover, it provides such a page-based personal logbook system wherein such at least one pre-assigned field comprises winners-placement results relating to each such individual-sports tournament. Additionally, it provides such a page-based personal logbook system wherein such at least one pre-assigned field comprises personal points awarded relating to each such individual-sports tournament. Also, it provides such a page-based personal logbook system further comprising: at least one indicia element to identify the type of such at least one sport; at least one indicia element to identify the name of at least one party sponsoring such plurality of individual-sports tournaments; and at least one explanation of the scoring system proposed by such at least one party relating to use in such plurality of individual-sports tournaments. In addition, it provides such a page-based personal logbook system wherein such at least one sport comprises martial arts. And, it provides such a page-based personal logbook system wherein such at least one sport comprises Taekwondo. Further, it provides such a page-based personal logbook system wherein such page-based personal logbook system comprises a paper-booklet-based system.

In accordance with another preferred embodiment hereof, this invention provides a page-based personal individual-sport tournaments logbook system comprising the steps of: identifying at least one individual-sport area comprising, over at least one tournament season, a plurality of tournaments relating to individual competitors; providing a plurality of logbooks, each comprising at least one plurality of pre-assigned fields adapted to assist entering of competition data relating to such plurality of tournaments, and at least one page organizer system adapted to assist page-organizing of such at least one plurality of pre-assigned fields relating to such tournaments; marketing such logbooks to at least one buyer; and selling such logbooks to such at least one buyer. Even further, it provides such a page-based personal individual-sport tournaments logbook system wherein the competition data comprises scores based on input from at least one judge. Moreover, it provides such a page-based personal individual-sport tournaments logbook system wherein such at least one plurality of pre-assigned fields comprise, relating to each such tournament, at least four such pre-assigned fields selected from the group consisting of tournament identification information, competitors-identification information, judges-identification information, scoring data from each judge relating to each competitor, winners-placement results, and personal points awarded. Additionally, it provides such a page-based personal individual-sport tournaments logbook system further comprising the steps of: identifying at least one scoring method relating to such at least one individual-sport area; providing at least one explanation of such at least one scoring method; and making such at least one explanation a part of each such logbook. Also, it provides such a page-based personal individual-sport tournaments logbook system further comprising the steps of: collecting contact information from such at least one buyer; and contacting such at least one buyer to solicit orders relating to such logbooks relating to at least one additional such at least one tournament season. In addition, it provides such a page-based personal individual-sport tournaments logbook system further comprising the steps of: providing printed such logbooks comprising a plurality of pages; providing, relating to essentially each such logbook, a swivel binding system permitting essentially each such page, when bound, to swivel; and binding such pages with such swivel binding system; wherein such at least one page organizer system permits such pages, when bound, to comprise single views relating to each of such plurality of tournaments. And, it provides such a page-based personal individual-sport tournaments logbook system wherein such page organizer system includes as part of such bound pages at least one indicia element selected from the group consisting of the type of such at least one individual sport area the name of at least one sponsoring party sponsoring such plurality of individual-sport tournaments. Further, it provides such a page-based personal individual-sport tournaments logbook system further comprising the step of offering such logbooks at a discounted rate to at least one party relating to fund raising purposes. Even further, it provides such a page-based personal individual-sport tournaments logbook system wherein such at least one individual-sport area comprises martial arts. Even further, it provides such a page-based personal individual-sport tournaments logbook system wherein such at least one individual-sport area comprises Taekwondo.

In accordance with another preferred embodiment hereof, this invention provides an Internet website computer system, relating to providing at least one personal individual-sport tournament logbook system, comprising, in combination: computer processor means relating to taking orders relating to a plurality of logbooks, each comprising at least one plurality of pre-assigned fields adapted to assist entering of competition data relating to a plurality of such individual-sport tournaments relating to at least one sport, and at least one page organizer system adapted to assist page-organizing of such at least one plurality of pre-assigned fields relating to such at least one tournament; computer interface means relating to marketing such logbooks to at least one buyer; and computer interface means relating to receiving payment relating to selling such logbooks at least primarily to such at least one buyer. Even further, it provides such an internet website computer system further comprising: computer interface means relating to collecting contact information from such at least one buyer; computer processor means relating to contacting such at least one buyer to solicit at least one order relating to such logbooks relating to at least one additional such at least one tournament season. Even further, it provides such a Internet website computer system wherein such at least one sport comprises martial arts. Even further, it provides such a Internet website computer system wherein such at least one sport comprises Taekwondo.

In accordance with another preferred embodiment hereof, this invention provides a page-based personal logbook system comprising, in combination: pre-assigned fields means relating to providing at least one plurality of pre-assigned fields relating to entering individual single-sport competition data relating to a plurality of individual-sports tournaments; and page organizer means relating to page-organizing of such pre-assigned fields means relating to such tournaments.

### BRIEF DESCRIPTION OF THE DRAWINGS

FIG. 1 is a simplified relational diagram showing the relationships between the logbook publisher and users for various methods of distribution, according to a preferred embodiment of the present invention.

FIG. 2 is flow diagram showing the preferred business method steps involved according to a preferred embodiment of the present invention.

FIG. 3 is an example cover of a personal competition logbook system according to a preferred embodiment of the present invention.

FIG. 4 is an example introduction page of a personal competition logbook system according to a preferred embodiment of the present invention.

FIG. 5 is an example explanation page of a personal competition logbook system according to a preferred embodiment of the present invention.

FIG. 6 is an example second explanation page of a personal competition logbook system according to a preferred embodiment of the present invention.

FIG. 7 is an example tournament summary page of a personal competition logbook system according to a preferred embodiment of the present invention.

FIG. 8 is an example detail tournament scoring page for forms/weapons competition of a personal competition logbook system according to a preferred embodiment of the present invention.

FIG. 9 is an example detail tournament scoring page for sparring competition of a personal competition logbook system according to a preferred embodiment of the present invention.

FIG. 10 is an example personal competition points log page of a personal competition logbook system according to a preferred embodiment of the present invention.

FIG. 11 is an example of a publisher contact page of a personal competition logbook system according to a preferred embodiment of the present invention.

FIG. 12 is an example of the home page of the website portion of a personal competition system according to a preferred embodiment of the present invention.

FIG. 13 is an example of the “About Us” page of the website portion of a personal competition system according to a preferred embodiment of the present invention.

FIG. 14 is an example of the product description page of the website portion of a personal competition system according to a preferred embodiment of the present invention.

FIG. 15 is an example of the order information page of the website portion of a personal competition system according to a preferred embodiment of the present invention.

FIG. 16 is an example of the contact information page website portion of a personal competition logbook system according to a preferred embodiment of the present invention.

FIG. 17 is a front view of a preferred bound logbook illustrating the logbook in a closed position and showing the swivel binding (shown as a “spiral” binding) according to a preferred embodiment of the present invention.

FIG. 18 is an inside view of the logbook of FIG. 17 spread in an upright open position and showing two facing pages of text material and showing the swivel binding (shown as a “spiral” binding) according to a preferred embodiment of the present invention.

FIG. 19 is an inside view of the logbook of FIG. 17 spread in a “sideways” or “portrait” open position and showing two facing pages offering a single view of entry fields sufficient for sixteen competitors, and showing the swivel binding (shown as a “spiral” binding) according to a preferred embodiment of the present invention.

### DETAILED DESCRIPTION OF BEST MODES AND PREFERRED EMBODIMENTS OF THE INVENTION

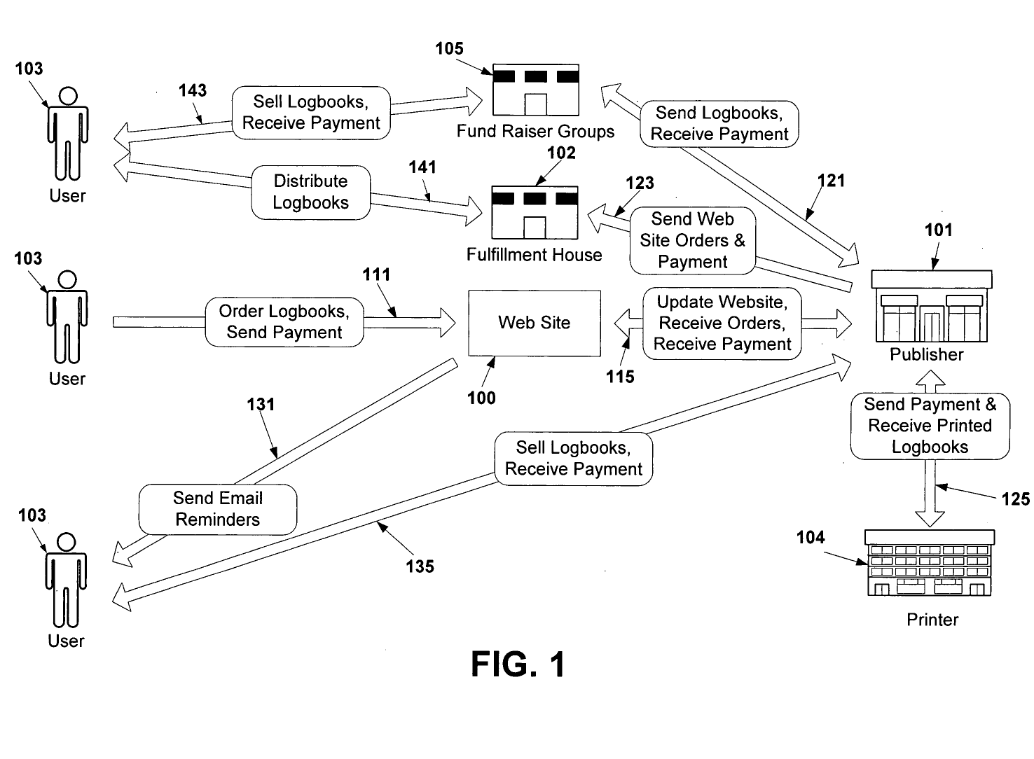

FIG. 1 is a simplified relational diagram showing the relationships between the publisher 101 of the logbooks and users 103 for various methods of distribution, according to a preferred embodiment of the present invention. According to a preferred embodiment of the present invention, printer 104 preferably receives payment from publisher 101 in exchange for printed personal competition logbook systems (also herein called logbooks 800) which printer 104 preferably prints according to layout and guidelines supplied by publisher 101, as indicated by flow 125 (embodying herein wherein said page-based personal logbook system comprises a paper-booklet-based system). Preferably, publisher 101 sells logbooks 800 directly to users 103 in exchange for payment, as indicated by flow 135. Publisher 101 may distribute logbooks 800 to fund raiser groups 105 in exchange for payment at a discounted rate, as indicated by flow 121 (embodying herein offering such logbooks at a discounted rate to at least one party relating to fundraising purposes). Fundraising groups 105 may then sell logbooks 800 to users 103 in exchange for payment, as indicated by flow 143. Publisher 101 may work with fulfillment house 102, as indicated by flow 123, to preferably provide a website for marketing to potential buyers which also allows users 103 to order logbooks 800 and make payments via the Internet, after which logbooks 800 are shipped to users 103 by fulfillment house 102, as indicated by flow 141 (embodying herein computer interface means relating to marketing such logbooks to at least one buyer; and embodying herein computer interface means relating to receiving payment relating to selling such logbooks at least primarily to such at least one buyer). Publisher 101 may directly maintain website 100 which allows publisher 101 to receive orders for logbooks 800 and payment via the Internet, after which logbooks 800 are shipped to users 103 by publisher 101, as indicated by flow 111. Preferably, Publisher 101 may accumulate a list of e-mail addresses from users 103, and send e-mail, as indicated by flow 131, reminding such users 103 when it is time to buy logbooks 800 for the next competition season, and/or to provide information about upcoming tournaments and other information related to the sport in which users 103 participate, etc., (embodying herein collecting contact information from such at least one buyer; and embodying herein computer interface means relating to collecting contact information from such at least one buyer; and embodying herein contacting such at least one buyer to solicit orders relating to such logbooks relating to at least one additional such at least one tournament season; and embodying herein such at least one buyer to solicit at least one order relating to such logbooks relating to at least one additional such at least one tournament season).

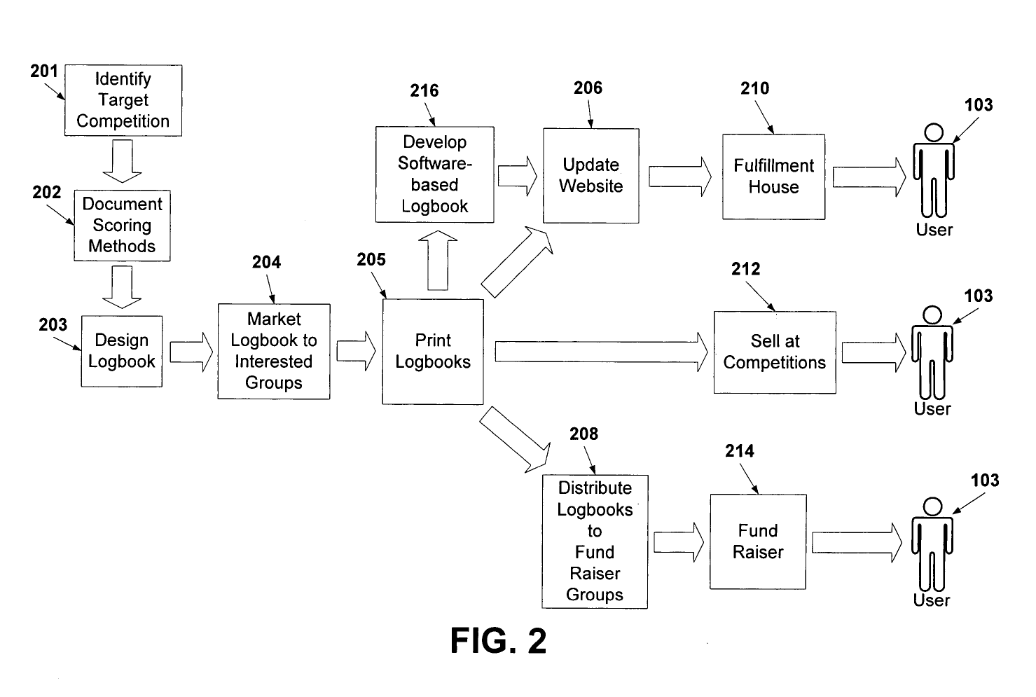

FIG. 2 is flow diagram showing the preferred business method steps involved in a preferred embodiment of the present invention. Preferably, publisher 101 begins by identifying target sport competition 201, preferably in an individual sport with multiple tournaments in a competitive season, preferably martial arts, preferably Taekwondo (embodying herein wherein such at least one individual-sport area comprises martial arts; and wherein such at least one individual-sport area comprises Taekwondo). Preferably, in identifying target competition 201, publisher 101 considers the potential demand, and related factors, for personal competition logbook systems 800 for users 103 of the associated sport (embodying herein identifying at least one individual-sport area comprising, over at least one tournament season, a plurality of tournaments relating to individual competitors). Preferably, publisher 101 documents the scoring methods 202 to assist in the step of determining how to most appropriately design logbook 203. Preferably, publisher 101 then markets the logbook to interested groups 204 and prints logbooks 205 (embodying herein marketing such logbooks to at least one buyer). Preferably, logbooks 800 are sold to users 103 at competitions 212 (embodying herein selling such logbooks to such at least one buyer). Preferably logbooks 800 are distributed at discounted rates to fundraising groups 208 for sale to users 103 as fundraisers 214. Preferably, a software-based logbook 216 is developed for use on handheld devices (for example a palm computer), and personal computers (for example, a notebook or desktop computer) for use instead of, or in conjunction with the printed logbooks 800. Preferably, website 206 allows users to order logbooks 800 and/or logbook software from fulfillment house 210 which distributes logbooks and logbook software to users 103 (embodying herein offering such logbooks at a discounted rate to at least one party relating to fund raising purposes).

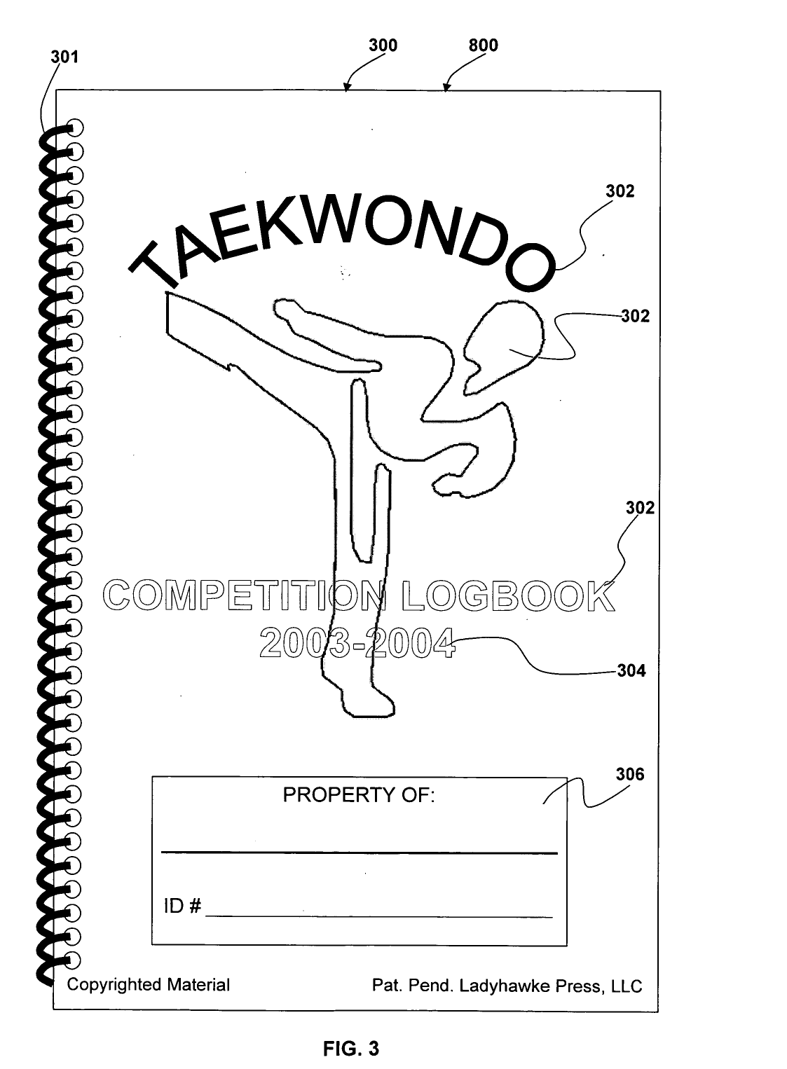

Referring now to FIG. 3, preferably, personal competition logbook system 800 comprises cover 300. Preferably, cover 300 comprises sport identification indicia 302 (embodying herein at least one indicia element to identify the type of said at least one sport), which assists users 103 in associating logbook 800 with the type sport (such as, for example, Taekwondo, as shown). For example, in the case of a personal competition logbook system tailored for the sport of Taekwondo, indicia preferably comprises a human figure wearing a martial arts uniform performing a recognizable Taekwondo kick, as shown. Upon reading this specification, those skilled in the art will now understand that, under appropriate circumstances, considering issues such as the type of sport, organizations, sponsors, etc., other types of indicia may be included, such as for example, the name of a sponsor, organization, school, team, etc., (embodying herein at least one indicia element to identify the name of at least one party sponsoring said plurality of individual-sports tournaments). Preferably, personal competition logbook system 800 is tailored and formatted for a specific sport, preferably a martial arts sport, preferably Taekwondo. Upon reading this specification, those skilled in the art will now understand that, under appropriate circumstances, considering issues such as number of competitors, market demand, etc., other sports, such as for example, gymnastics, figure skating, etc., may suffice. Preferably, cover 300 comprises season identification indicia 304, which assists users 103 in identifying which competitive season logbook 800 records. Preferably, cover 300 comprises ownership identification field 306, which provides a place for users 103 to fill in data (such as, for example, their name and membership ID) that assists users 103 in personalizing their logbook 800 so that proper ownership can easily be identified. Preferably, cover 300 comprises logbook identification indicia 308.

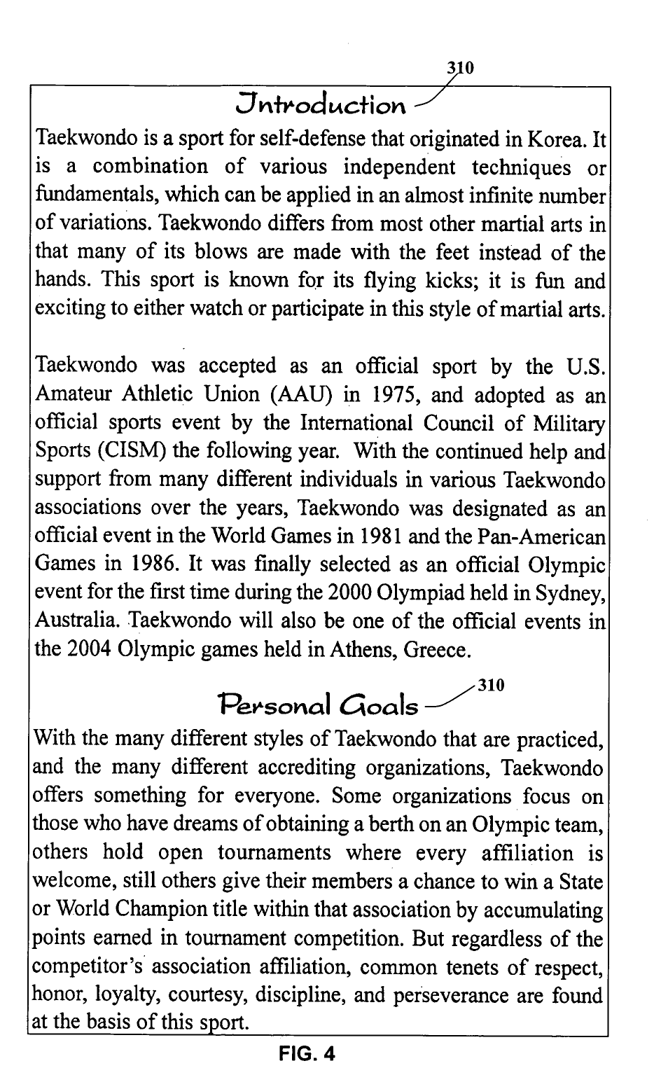

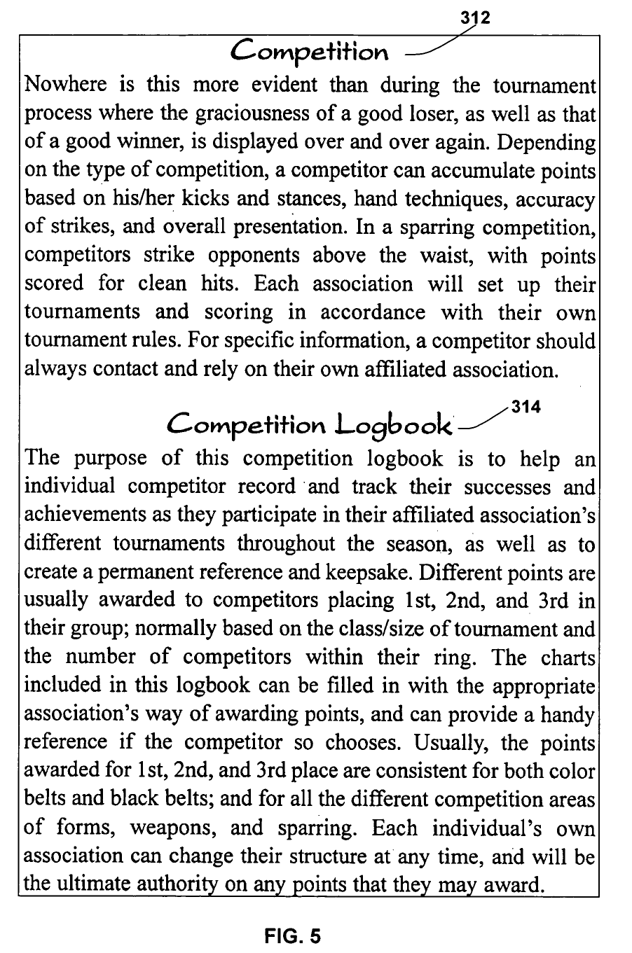

FIGS. 4-11 are example portions of a personal competition logbook system 800 according to a preferred embodiment of the present invention. Preferably, personal competition logbook system 800 comprises sport information 310 (such as, for example, the history of the sport, variations of the sport, organizations involved in the sport, governing authorities in the sport, etc.), which assists users 103 in understanding the sport.

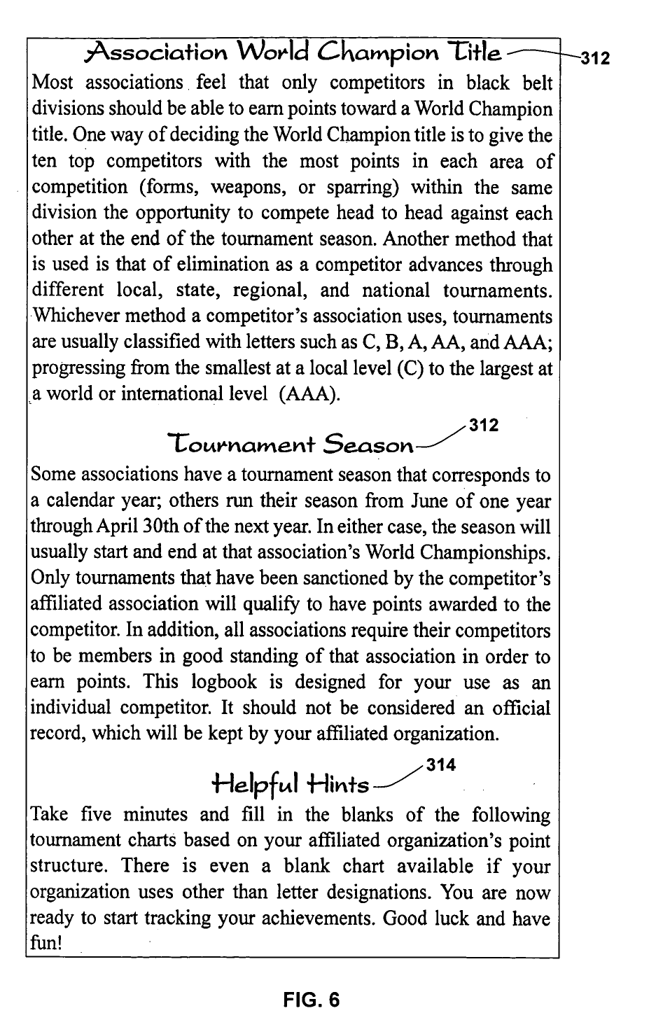

As shown in FIG. 6, preferably, personal competition logbook system 800 comprises competition information 312 (such as, for example, information about different events at the competition, how events and competitions are judged and scored, rules of the events and tournaments, etc.), which assists users 103 in understanding the events and competitions (embodying herein at least one explanation of the scoring system proposed by said at least one party relating to use in said plurality of individual-sports tournaments). Preferably, competition information 312 comprises eligibility requirements to qualify for the tournaments, rules and scoring procedures of the tournament events. Preferably, personal competition logbook system 800 comprises logbook information 314, which instructs and assists users 103 in understanding how to use logbook system 800, such as, for example, the benefits of keeping a personal logbook, and how to properly enter data in logbook 800. FIG. 6 shows example competition information 312 and logbook information 314.

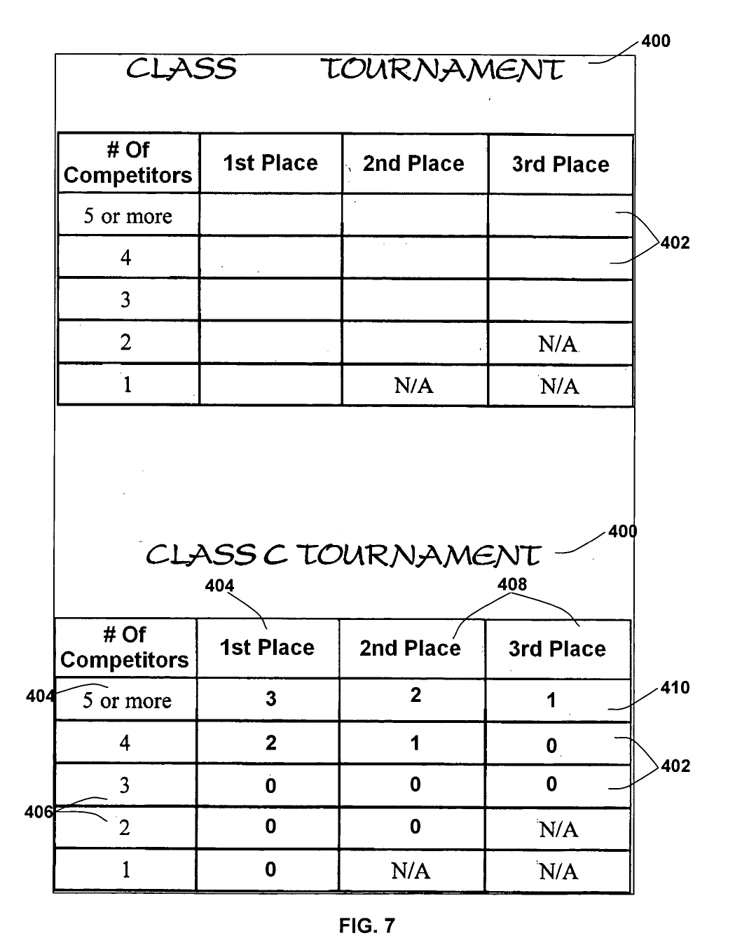

Some governing sports authorities have ranking systems that assign points to competitors based on winning events in tournaments. In many sports, such as, for example, Taekwondo, the number of points assigned depends upon factors, such as, for example, whether the tournament is a small local tournament (which would be worth relatively less points towards ranking), or a large multi-regional tournament (which would be worth relatively more points). Different organizations assign different points to the various classifications of tournaments, and the organizations can change the point system from one year to the next. Preferably, competition logbook system 800 comprises tournament identifier indicia 400, such as, for example, tournament classification, categorization, etc. Preferably, competition logbook system 800 comprises tournament scoring factors 404, such as, for example, number of competitors 406 and competition rank 408. Preferably, competition logbook system 800 comprises tournament scoring structure fields 402, which allow users 103 to enter the appropriate tournament points 410 for the given combinations of tournament scoring factors 404, based upon the system adopted by the governing sport authority or organization (embodying herein making such at least one explanation a part of each such logbook). FIG. 7 shows one table of tournament scoring structure fields 402 in which the fields are empty, and another table of tournament scoring structure fields 402 that have been filled with example tournament points 410.

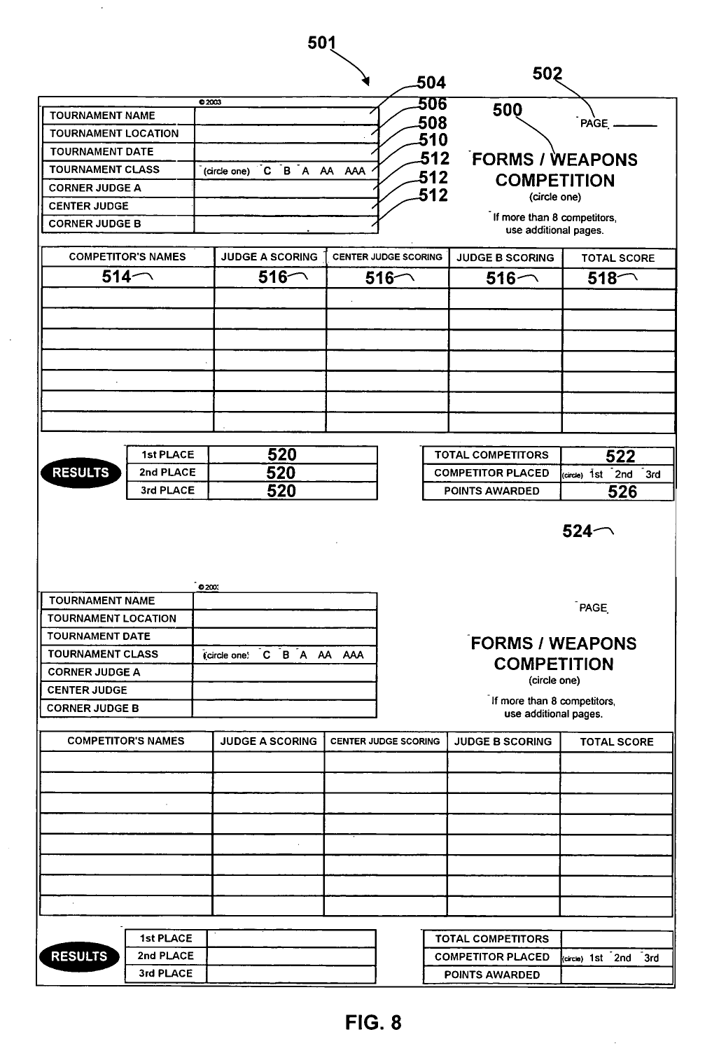

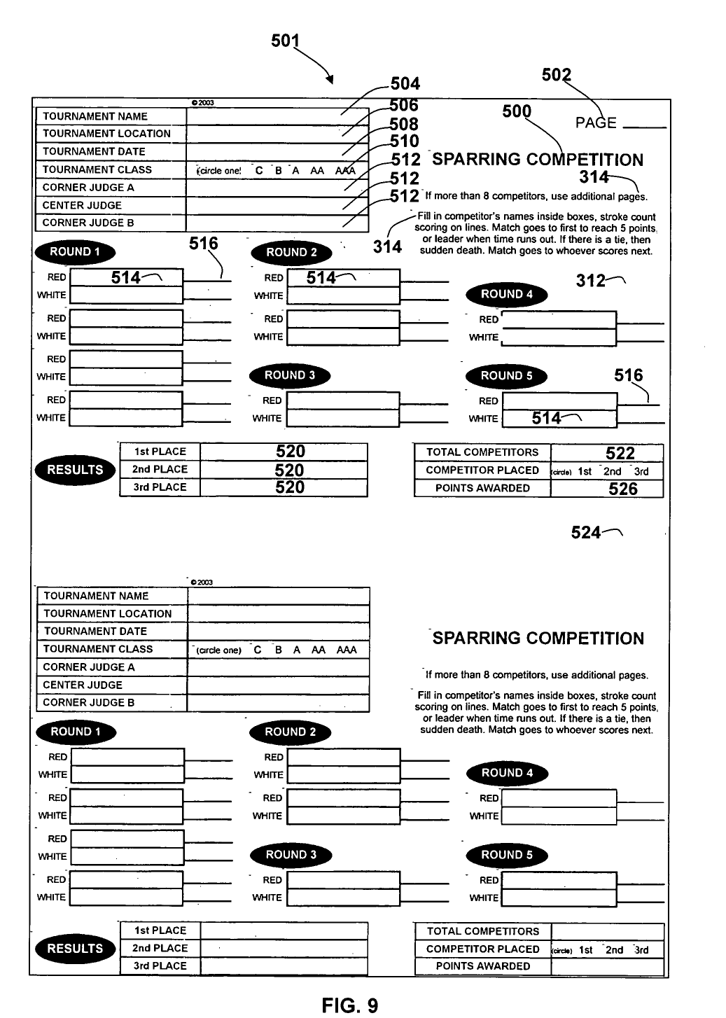

FIGS. 8 and 9 are examples of a portion of a personal competition logbook system 800 according to a preferred embodiment of the present invention showing an event form 501 which can be filled out by users 103 to record data about a competition event. Preferably, event form 501 comprises identifier indicia 500, which assists users 103 to identify which event is being recorded. Preferably, event form 501 comprises pagination field 500, which provides users 103 with a place to paginate event form 501. Preferably, event form 501 comprises tournament name field 504, which prompts and provides the user with a place to record the tournament name (embodying herein wherein said at least one pre-assigned field comprises tournament identification information relating to each said individual-sports tournament). Preferably, event form 501 comprises tournament location field 506, which prompts and provides user with a place to record the tournament location. Preferably, event form 501 comprises tournament date field 508, which prompts and provides user with a place to record the tournament date. Preferably, event form 501 comprises tournament class field 510, which prompts and provides user with a place to record the tournament class.

Preferably, event form 501 comprises at least one judge name field 512, which prompts and provides user with a place to record the name(s) of the event judge(s) (embodying herein wherein said at least one pre-assigned field comprises judges-identification information relating to each said individual-sports tournament). Preferably, event form 501 comprises at least one competitor name field 514, which prompts and provides user with a place to record the name(s) of the competitor(s) (embodying herein wherein said at least one pre-assigned field comprises competitors-identification information relating to each said individual-sports tournament). Preferably, event form 501 comprises at least one judge scoring field 516, which prompts and provides user with a place to record the score(s) of the event judge(s) (embodying herein wherein said individual single-sport competition data comprises at least one score based on input from at least one judge; and embodying herein wherein said at least one pre-assigned field comprises scoring data from each judge relating to each competitor relating to each said individual-sports tournament). Preferably, event form 501 comprises at least one scoring summation field 518, which prompts and provides user with a place to record the summary scores(s) for each competitor. Preferably, event form 501 comprises at least one competition rank 520, which prompts and provides user with a place to record the names of the top ranked competitors in the event (embodying herein wherein said at least one pre-assigned field comprises winners-placement results relating to each said individual-sports tournament). Preferably, event form 501 comprises at least one number-of-competitors field 522, which prompts and provides user with a place to record the number of competitors in the event, which, as mentioned herein, can have an impact on overall ranking. Preferably, event form 501 comprises at least one competition rank field 524, which prompts and provides user with a place to record the competitor's rank in the event, and a competition points field, which prompts and provides user with a place to record the associated competition points (embodying herein wherein said at least one pre-assigned field comprises personal points awarded relating to each said individual-sports tournament).

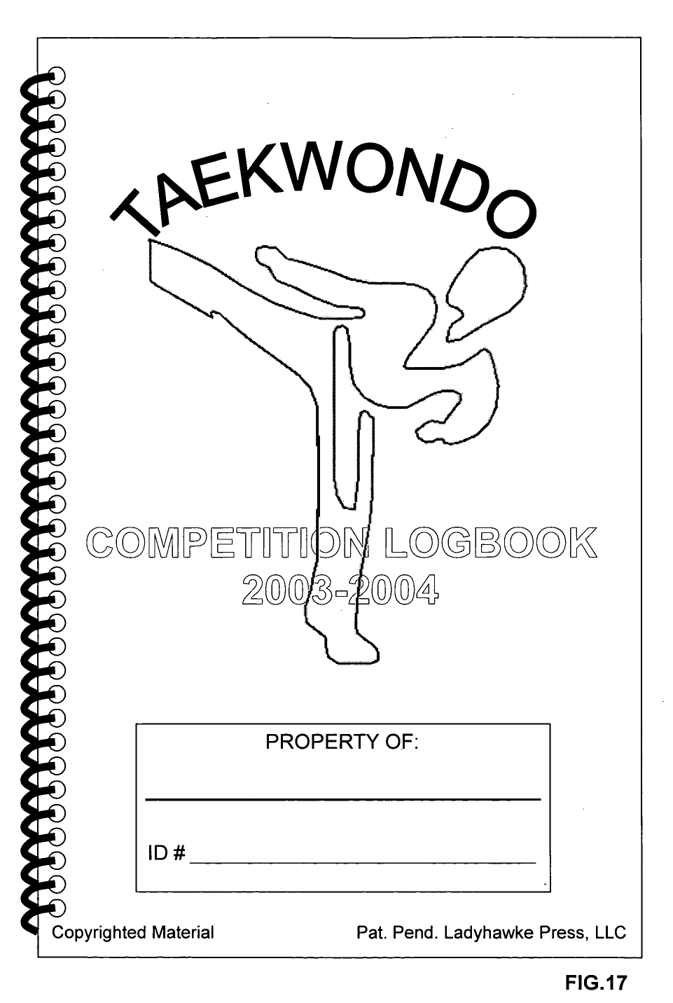

Preferably, competition logbook system 800 comprises a plurality of event forms 501, chronologically ordered so that users 103 can enter data, record and track events for all the tournaments in a competitive season (embodying herein at least one plurality of pre-assigned fields adapted to assist entering of individual single-sport competition data relating to at least one plurality of individual-sports tournaments relating to at least one sport; and embodying herein at least one page organizer system adapted to assist page organizing of said at least one plurality of pre-assigned fields relating to at least one said individual-sports tournament; and embodying herein pre-assigned fields means relating to providing at least one plurality of pre-assigned fields relating to entering individual single-sport competition data relating to a plurality of individual-sports tournaments; and embodying herein page organizer means relating to page-organizing of such pre-assigned fields means relating to such tournaments). Preferably, competition logbook system 800 comprises bound pages (see FIGS. 17-19) with a plurality of event forms 501, thus providing users 103 with portability and convenience in tracking many events (embodying herein wherein said at least one page organizer system comprises bound paper pages comprising said at least one plurality of pre-assigned fields). As used in these teachings the term “bound” encompasses the use of any mechanism or attachment method which permits the pages of the logbook system 800 to be held together, yet swivel.

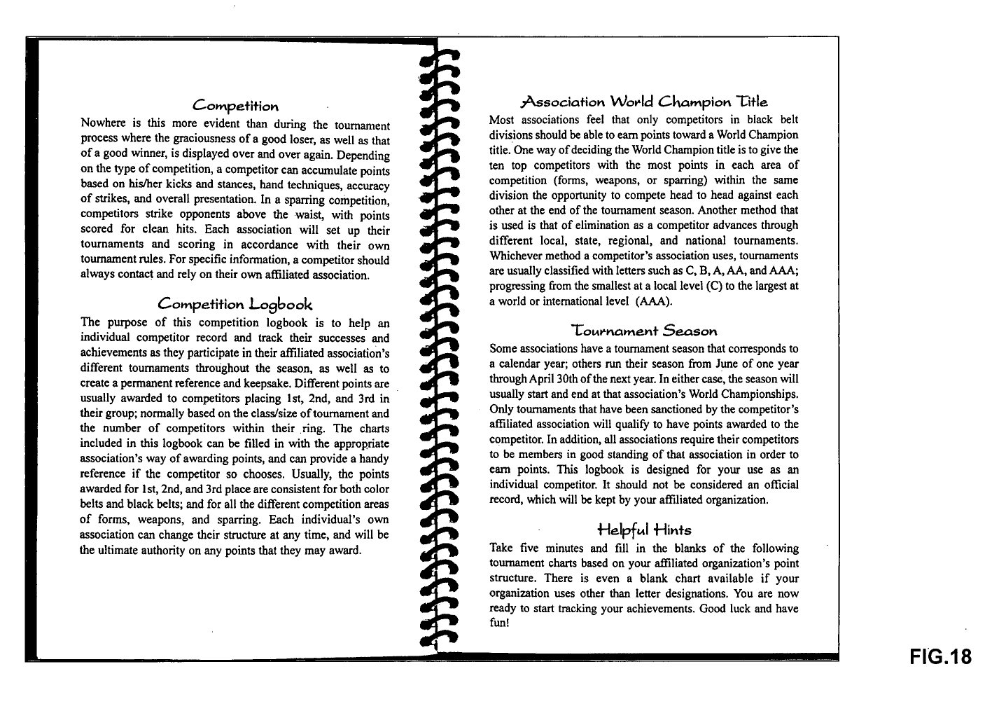

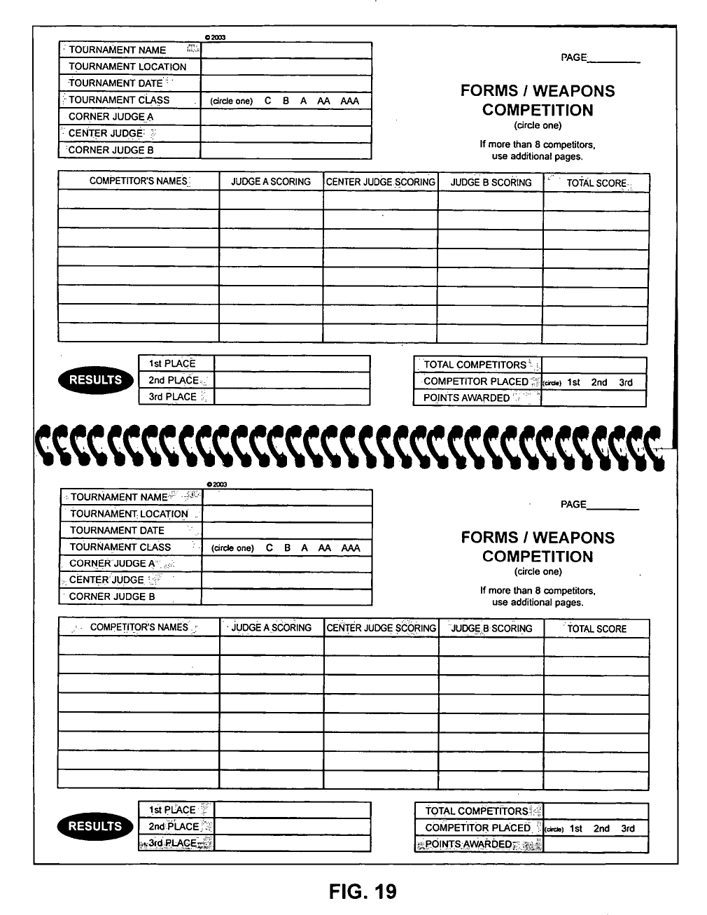

Preferably, competition logbook system 800 is bound by a swivel binding 301 (See FIG. 3, FIG. 17, FIG. 18 and FIG. 19), which allows pages, when bound, to swivel at least about 180 degrees (embodying herein providing, relating to essentially each such logbook, a swivel binding system permitting essentially each such page, when bound, to swivel; and embodying herein binding such pages with such swivel binding system). Preferably, event forms 501 are formatted and graphically designed so that a single view is sufficient to view the fields and data for an event, as shown in FIG. 19, for example, without having to flip pages to view all the data of a single event (embodying herein wherein said bound paper pages comprise single views related to each of said plurality of individual-sports tournaments; and embodying herein wherein said bound paper pages comprise single views related to each of said plurality of individual-sports tournaments). Preferably, event form 501 comprises competition information 312, and logbook information 314, as mentioned herein.

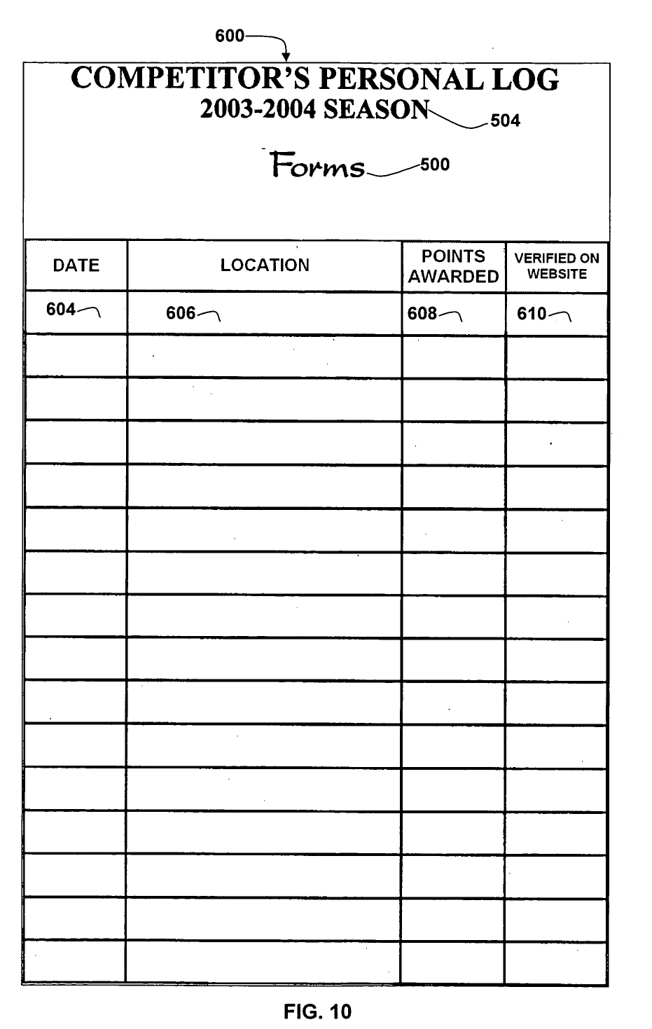

FIG. 10 is an example of a portion of a personal competition logbook system 800 according to a preferred embodiment of the present invention, showing a season event summary 600. Preferably, season event summary 600 comprises season identification indicia 304, so users 103′ can easily identify which competitive season is summarized. Preferably, season event summary 600 comprises event identifier indicia 500, so users 103 can easily identify which event is summarized. Preferably, season event summary 600 comprises a plurality of competition date fields 604, which prompts and provides user 103 with a place to record the dates of competitions to be summarized. Preferably, season event summary 600 comprises a plurality of competition location fields 606, which prompts and provides user 103 with a place to record the location of competitions. Preferably, season event summary 600 comprises a plurality of points awarded fields 608, which prompts and provides user 103 with a place to record the points awarded at the competitions. Preferably, season event summary 600 comprises a plurality of verification fields 606, which prompts and provides user 103 with a place to record that they have confirmed and reconciled the points awarded to the competitor with the appropriate governing sports authority or organization.

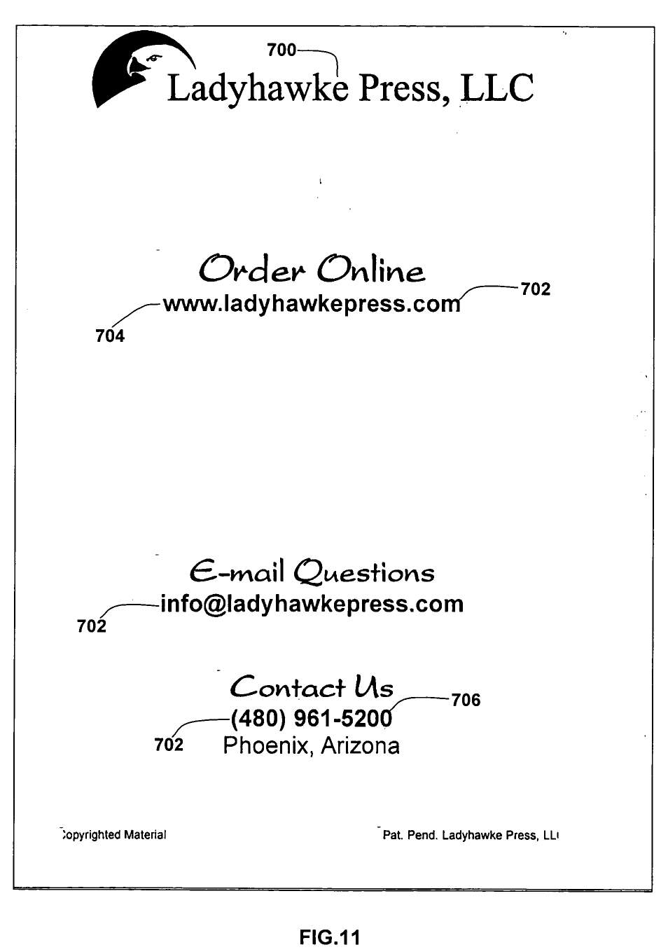

As shown in FIG. 11, an example portion of a preferred embodiment of the present invention, preferably competition logbook system 800, comprises publisher branding indicia 700 and publisher contact information 702, to assist the publisher in promoting the sale of additional logbook systems 800 and to assist the users 103 with obtaining logbook systems 800 and other related information and material. Preferably, publisher contact information 702 comprises publisher website address 704, and publisher phone number 706.

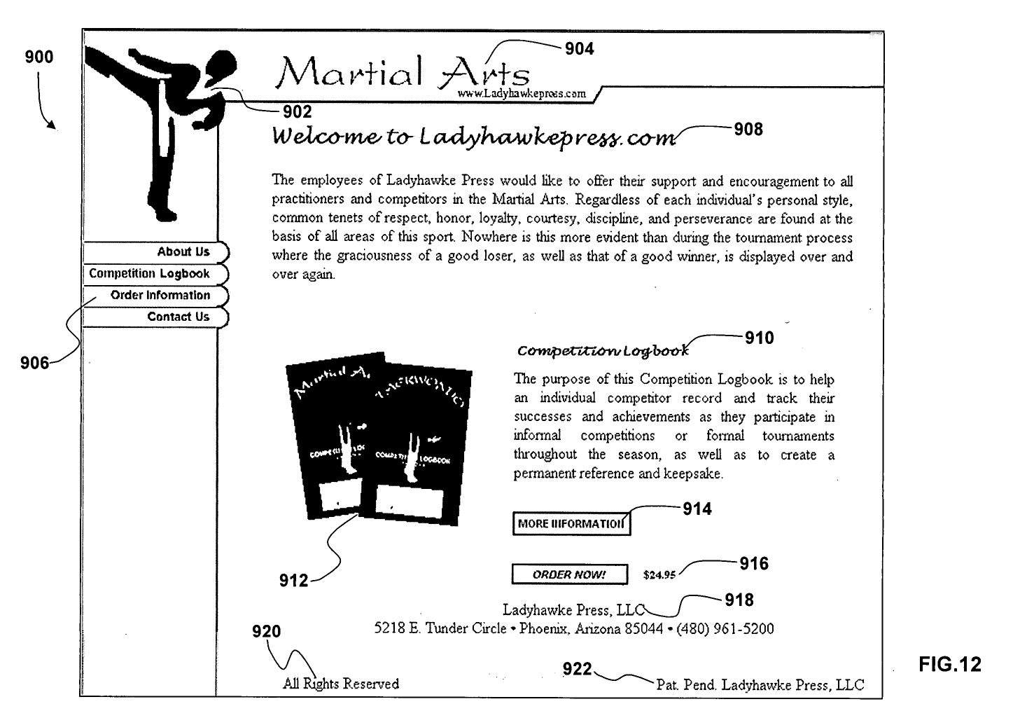

FIG. 12 illustrates an example webpage 900 from an example website of publisher 101, “www.ladyhawkepress.com”, according to a preferred embodiment of the present invention. Preferably, webpage 900 comprises sport identification indicia 902 which assist users 103 in associating webpage 900 with the type of sport (such as, for example, martial arts, as shown). Preferably, webpage 900 may comprise further sport identification indicia 904. Preferably, webpage 900 comprises links 906 for linking to webpages 924, 930, 934, and 948 (illustrated in other figures herein), as shown. Preferably, webpage 900 comprises information 908 about publisher 101 (such as, its respect and appreciation for the martial arts, etc.), which assists users 103 in understanding the disposition of the website operator. Preferably, webpage 900 comprises competition logbook information 910 (such as, the purpose of the logbook, etc.), which assists users 103 in understanding the goal behind producing the logbook 800, as shown.

Preferably, webpage 900 comprises logbook appearance indicia 912, as shown, which assists users 103 in ascertaining the appearance and dimensions of the logbook 800. Preferably, webpage 900 comprises another link 914, which offers users 103 another link to webpage 930, as shown. Preferably, webpage 900 comprises another link 916, which offers users 103 another link to webpage 934, as well as offering the price of each logbook 800, as shown. Preferably, webpage 900 comprises the website location and contact information 918 (such as, address, phone number, etc.) for publisher 101, which assists users 103 interested in locating or contacting publisher 101. Preferably, webpage 900 comprises a legal notice 920, which informs users 103 that publisher 101 has not disclaimed its legal rights, as shown. Preferably, webpage 900 comprises another legal notice 922, which informs users 103 of its intellectual property rights, as shown.

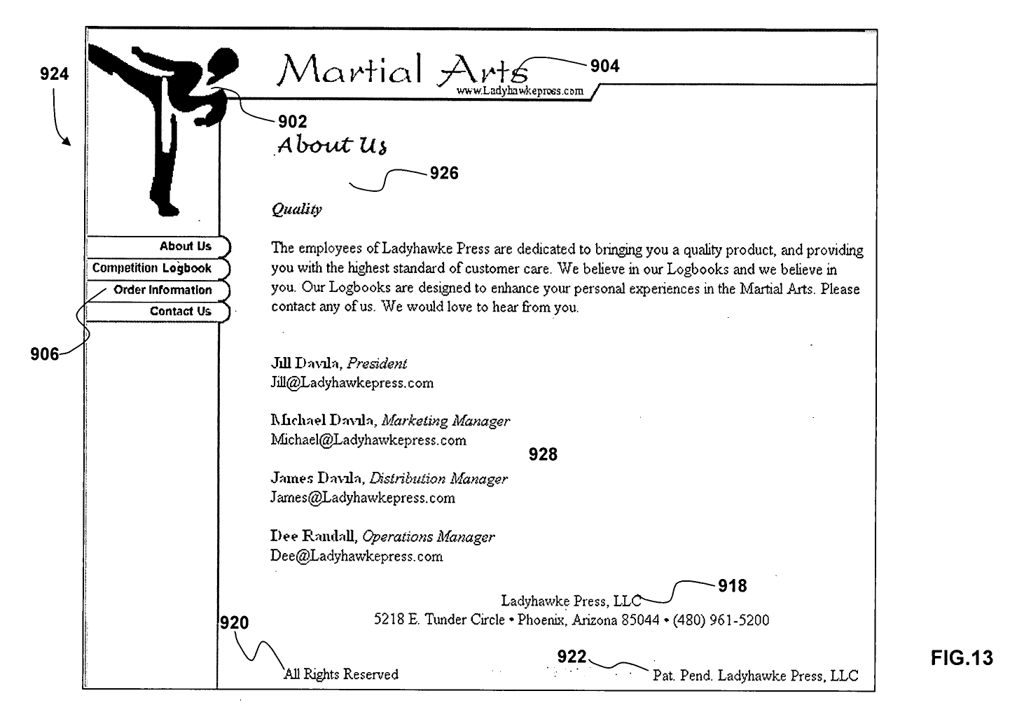

FIG. 13 illustrates another preferred example webpage 924, according to a preferred embodiment of the present invention. Preferably, webpage 924 comprises employee information 926 (such as, their dedication to quality and customer care, etc.) of publisher 101, which assists users 103 in understanding the viewpoints of publisher 101. Preferably, webpage 924 comprises management information 928 (such as, employee titles and e-mail addresses, etc.) of publisher 101, which assists users 103 in contacting specific employees.

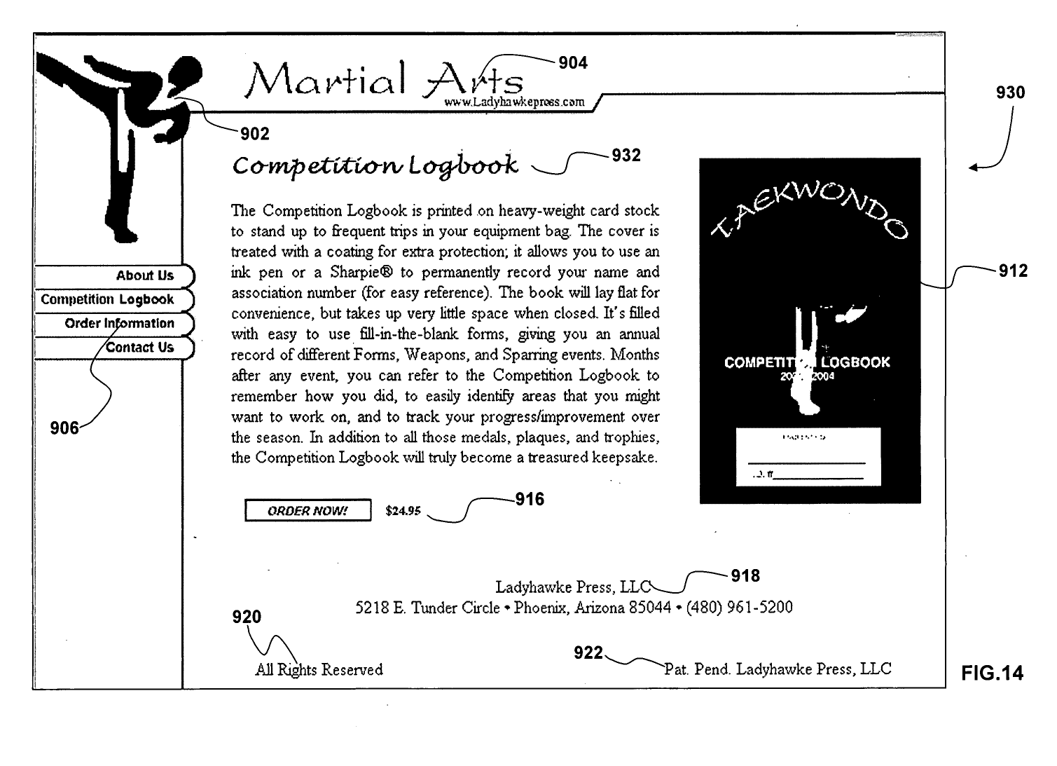

FIG. 14 illustrates another example of a preferred webpage 930, according to a preferred embodiment of the present invention. Preferably, webpage 930 comprises detailed competition logbook information 932 (such as, it is printed on heavy-weight card stock, durability, format, etc.), as shown, which assists users 103 in understanding the characteristics of the competition logbook 800.

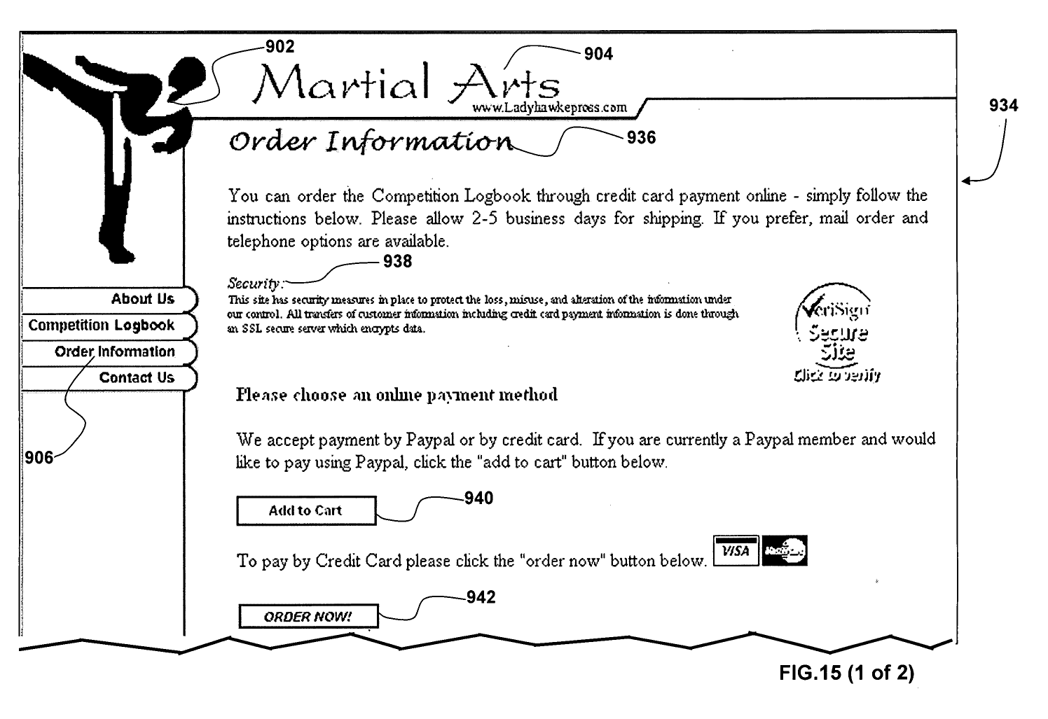

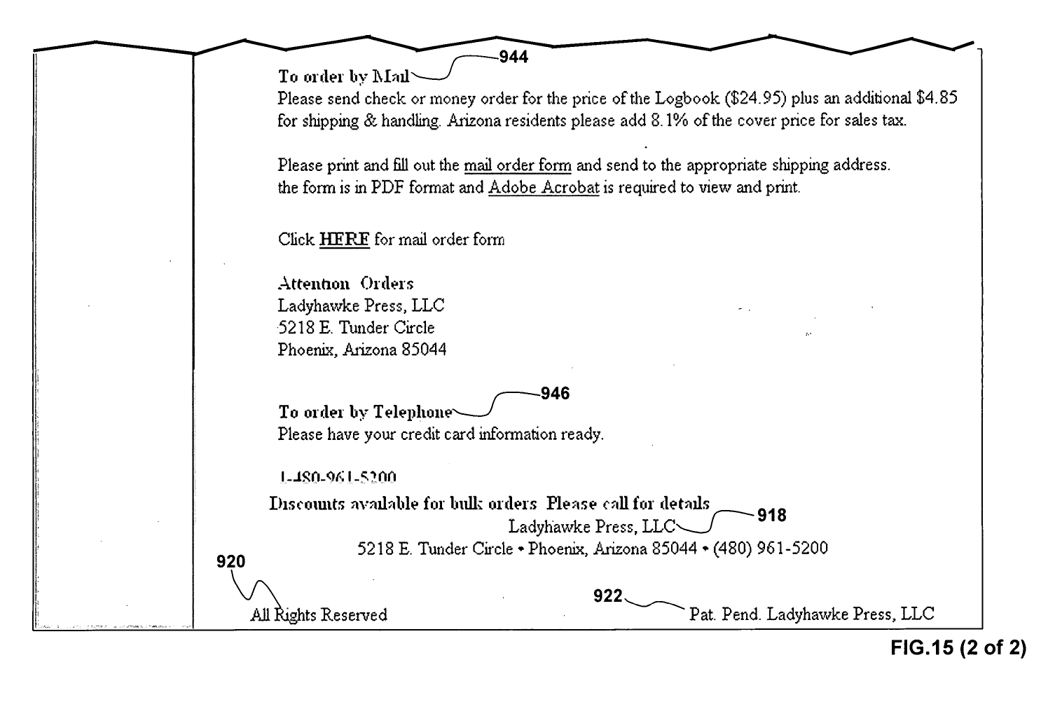

FIG. 15 illustrates another preferred webpage 934 according to a preferred embodiment of the present invention. Preferably, webpage 934 comprises ordering information 936, which informs users 103 that publisher 101 takes orders online, by mail, by phone, and accepts credit cards, as shown. Preferably, webpage 934 comprises a security notice 938, as shown, which may help assure users 103 that publisher 101 is secure for online purchases. Preferably, webpage 934 comprises an “add to cart” link 940, which allows users 103 to link to and purchase logbooks from “PayPal”, as shown. Preferably, webpage 934 comprises an “order now” link 942, which allows users 103 to link to a credit card purchase site for purchasing logbooks, as shown. Preferably, webpage 934 comprises information and links regarding mail orders 944, which provides users 103 with information about shipping and handling fees as well as links to downloadable mail order forms. Preferably, webpage 934 comprises information for telephone orders 946, which provides users 103 with a phone number for making such telephone purchases of logbooks 800.

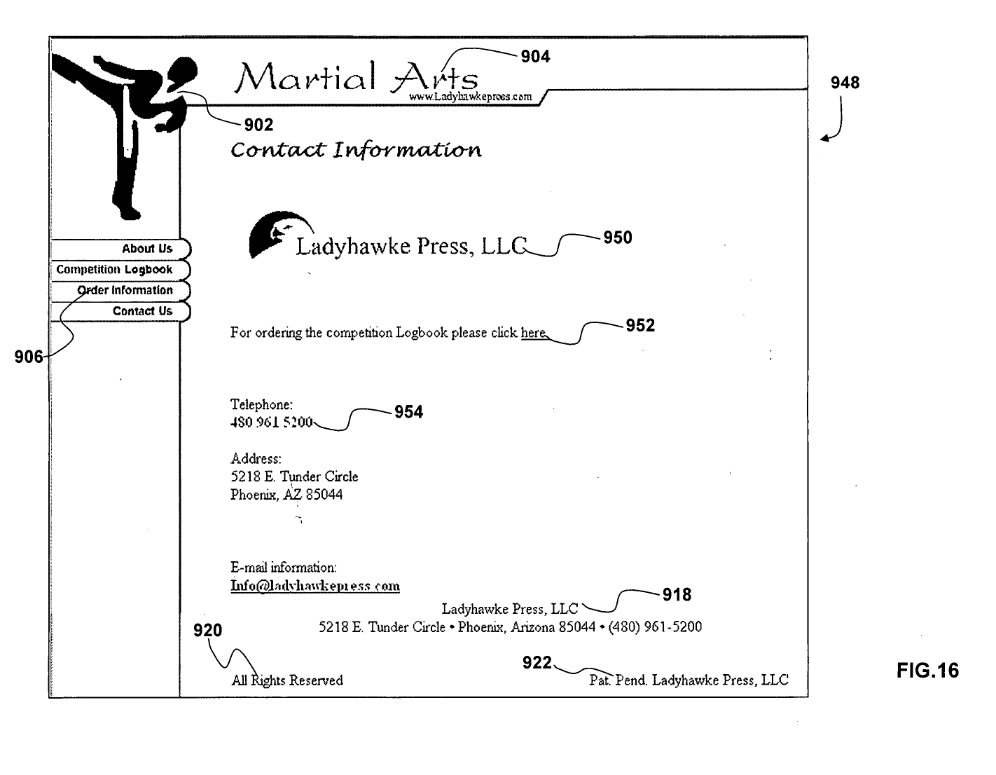

FIG. 16 illustrates webpage 948 according to a preferred embodiment of the present invention. Preferably, webpage 948 comprises business entity indicia 902 of publisher 101. Preferably, webpage 900 comprises a link 952, which offers users 103 another link to the order information of webpage 934. Preferably, webpage 948 comprises contact information 926 (such as, telephone number, address, e-mail, etc.) of publisher 101, which assists users 103 in contacting publisher 101, comprising a link for opening e-mail software.

FIG. 17 is a front view of a preferred bound logbook 800 according to this invention illustrating such logbook in a closed position and showing the swivel binding (shown as a “spiral” binding) preferably used, as herein described.

FIG. 18 is an inside view of the logbook of FIG. 17 spread in an upright open position and preferably showing two facing pages of text material, as herein described.

FIG. 19 is an inside view of the logbook of FIG. 17 spread in a “sideways” or “portrait” open position and showing two facing pages preferably offering a single view of sufficiently many entry fields as disclosed herein for the entry of data for a complete tournament, even with sixteen competitors, as herein described.

Although applicant has described applicant's preferred embodiments of this invention, it will be understood that the broadest scope of this invention includes such modifications as diverse shapes and sizes and materials. Such scope is limited only by the below claims as read in connection with the above specification.

Further, many other advantages of applicant's invention will be apparent to those skilled in the art from the above descriptions and the below claims.

What is claimed is:

1) A page-based personal logbook system comprising, in combination:
a) at least one plurality of pre-assigned fields adapted to assist entering of individual single-sport competition data relating to at least one plurality of individual-sports tournaments relating to at least one sport; and
b) at least one page organizer system adapted to assist page-organizing of said at least one plurality of pre-assigned fields relating to at least one plurality of individual-sports tournaments.

2) The page-based personal logbook system according to claim 1 wherein said individual single-sport competition data comprises at least one score based on input from at least one judge.

3) The page-based personal logbook system according to claim 2 wherein said at least one page organizer system comprises bound paper pages comprising said at least one plurality of pre-assigned fields.

4) The page-based personal logbook system according to claim 3 wherein said bound paper pages comprise single views related to each of the at least one plurality of individual-sports tournaments.

5) The page-based personal logbook system according to claim 4 wherein said at least one pre-assigned field comprises tournament identification information relating to each of the at least one plurality of individual-sports tournaments.

6) The page-based personal logbook system according to claim 4 wherein said at least one pre-assigned field comprises competitors-identification information relating to each of the at least one plurality of individual-sports tournaments.

7) The page-based personal logbook system according to claim 4 wherein said at least one pre-assigned field comprises judges-identification information relating to each of the at least one plurality of individual-sports tournaments.

8) The page-based personal logbook system according to claim 4 wherein said at least one pre-assigned field comprises scoring data from each judge relating to each competitor relating to each of the at least one plurality of individual-sports tournaments.

9) The page-based personal logbook system according to claim 4 wherein said at least one pre-assigned field comprises winners-placement results relating to each of the at least one plurality of individual-sports tournaments.

10) The page-based personal logbook system according to claim 4 wherein said at least one pre-assigned field comprises personal points awarded relating to each said individual-sports tournament.

11) The page-based personal logbook system according to claim 1 further comprising:
a) at least one indicia element to identify the type of said at least one sport;
b) at least one indicia element to identify the name of at least one party sponsoring of the at least one plurality of individual-sports tournaments; and
c) at least one explanation of the scoring system proposed by said at least one party relating to use in the at least one plurality of individual-sports tournaments.

12) The page-based personal logbook system according to claim 1 wherein said at least one sport comprises martial arts.

13) The page-based personal logbook system according to claim 1 wherein said at least one sport comprises Taekwondo.

14) The page-based personal logbook system according to claim 1 wherein said page-based personal logbook system comprises a paper-booklet-based system.

15) A page-based personal individual-sport tournaments logbook system comprising the steps of:
a) identifying at least one individual-sport area comprising, over at least one tournament season, a plurality of tournaments relating to individual competitors;
b) providing a plurality of logbooks, each comprising
i) at least one plurality of pre-assigned fields adapted to assist entering of competition data relating to such plurality of tournaments, and
ii) at least one page organizer system adapted to assist page-organizing of such at least one plurality of pre-assigned fields relating to such tournaments;
c) marketing such logbooks to at least one buyer; and
d) selling such logbooks to such at least one buyer.

16) The page-based personal individual-sport tournaments logbook system according to claim 15 wherein the competition data comprises scores based on input from at least one judge.

17) The page-based personal individual-sport tournaments logbook system according to claim 15 wherein such at least one plurality of pre-assigned fields comprise, relating to each such tournament, at least four such pre-assigned fields selected from the group consisting of:
a) tournament identification information;
b) competitors-identification information;
c) judges-identification information;
d) scoring data from each judge relating to each competitor;
e) winners-placement results; and
f) personal points awarded.

18) The page-based personal individual-sport tournaments logbook system according to claim 15 further comprising the steps of:
a) identifying at least one scoring method relating to such at least one individual-sport area;
b) providing at least one explanation of such at least one scoring method; and
c) making such at least one explanation a part of each such logbook.

19) The page-based personal individual-sport tournaments logbook system according to claim 15 further comprising the steps of:
a) collecting contact information from such at least one buyer; and
b) contacting such at least one buyer to solicit orders relating to such logbooks relating to at least one additional such at least one tournament season.

20) The page-based personal individual-sport tournaments logbook system according to claim 15 further comprising the steps of:
a) providing printed such logbooks comprising a plurality of pages;
b) providing, relating to essentially each such logbook, a swivel binding system permitting essentially each such page, when bound, to swivel; and
c) binding such pages with such swivel binding system;
d) wherein such at least one page organizer system permits such pages, when bound, to comprise single views relating to each of such plurality of tournaments.

21) The page-based personal individual-sport tournaments logbook system according to claim 20 wherein such page organizer system includes as part of such bound pages at least one indicia element selected from the group consisting of:
i) the type of such at least one individual sport area; and
ii) the name of at least one sponsoring party sponsoring such plurality of individual-sport tournaments.

22) The page-based personal individual-sport tournaments logbook system according to claim 15 further comprising the step of offering such logbooks at a discounted rate to at least one party relating to fundraising purposes.

23) The page-based personal individual-sport tournaments logbook system according to claim 15 wherein such at least one individual-sport area comprises martial arts.

24) The page-based personal individual-sport tournaments logbook system according to claim 15 wherein such at least one individual-sport area comprises Taekwondo.

25) An Internet website computer system, relating to providing at least one personal individual-sport tournament logbook system, comprising, in combination:
a) computer processor means relating to taking orders relating to a plurality of logbooks, each comprising
i) at least one plurality of pre-assigned fields adapted to assist entering of competition data relating to a plurality of such individual-sport tournaments relating to at least one sport, and
ii) at least one page organizer system adapted to assist page-organizing of such at least one plurality of pre-assigned fields relating to such at least one tournament;
b) computer interface means relating to marketing such logbooks to at least one buyer; and
c) computer interface means relating to receiving payment relating to selling such logbooks at least primarily to such at least one buyer.

26) The Internet website computer system according to claim 25 further comprising:
a) computer interface means relating to collecting contact information from such at least one buyer;
b) computer processor means relating to contacting such at least one buyer to solicit at least one order relating to such logbooks relating to at least one additional such at least one tournament season.

27) The Internet website computer system according to claim 25 wherein such at least one sport comprises martial arts.

28) The Internet website computer system according to claim 25 wherein such at least one sport comprises Taekwondo.

29) A page-based personal logbook system comprising, in combination:
a) pre-assigned fields means relating to providing at least one plurality of pre-assigned fields relating to entering individual single-sport competition data relating to a plurality of individual-sports tournaments; and
b) page organizer means relating to page-organizing of said pre-assigned fields means relating to such tournaments.
